(19) United States
(12) Patent Application Publication
(10) Pub. No.: US 2002/0135177 A1
(43) Pub. Date: Sep. 26, 2002

(54) Method for creating a single continous design tiled from multiple images and an article for viewing the single continous design

(76) Inventor: Stephen R. Welch, Roselle, IL (US)

Correspondence Address: Jack Shore, Hamman & Benn, Suite 3300, 10 South LaSalle Street, Chicago, IL, 60603, US

(21) Appl. No.: 09/816,812

(22) Filed: Mar. 26, 2001

(51) Int. Cl. B42C 7/00; B42D 3/08

(52) U.S. Cl. 281/31; 281/51; 402/3; 402/70; 402/73

(57) ABSTRACT

The preferred method includes the steps of receiving a design, resizing the design to a predetermined size, separating the design into multiple images, which when properly tiled form the design, and printing the design on multiple sheets of paper. The article is preferably a binder having a pocket disposed about the binder's cover. The pocket has an interior length substantially equal to the predetermined size, which when the properly tiled sheets are inserted in the pocket the sheets form a single, continuous, unbroken design which is viewed through the pocket. The pocket is preferably a clear overlay but may include in various embodiments lenticular lenses, which provide the ability to insert a combined design interlaced, such that when viewed through the lenticular lenses at various angles results in the separate visualization of the two designs.

### FIELD OF THE INVENTION

This invention relates generally to binders and particularly to a method for creating a single continuous and unbroken design tiled from multiple images individually printed and disposed about an article for viewing the design.

### BACKGROUND OF THE INVENTION

Conventional binders are constructed with a three-piece cover forming a front cover, a back cover and a spine in between, wherein the spine is of a much narrower width than the other two. In the manufacturing of such binders, inner and outer sheets of plastic are fused together about their peripheral edges and at the demarcations between the spine and the two covers, also known as the hinge of the binder, it may also be approximately ⅛″ wide separating the paper inserts by ¼″ at least. Moreover, at the demarcations the plastic is further crimped to form hinges. Manufacturing further provides binders out of a single piece of plastic to form a binder having a front and back cover area and spine area therebetween, with portions crimped to form hinges. In both such instances the overall length of the material used to form the binder changes depending upon the width needed to form the spine, since the width of the spine typically changes in relationship to the size of the ring mechanism, i.e. a larger spine is needed for a 2″ capacity ring mechanism then for a ½″ capacity. However, it is foreseeable that the manufacturing of a binder equipped for a larger capacity ring mechanism may be used for a smaller ring capacity. In addition, U.S. patent application Ser. No. 09/408399 owned by the inventor and applicant herein discloses a binder using a single uncompromised board which includes the formation of longitudinal knuckles or living hinges that provides the binder with the ability to hinge or open at these knuckles. While the particular formation of binders may change or various materials used to make the same may change, the binder when formed and completed includes a cover area formed from the outer surface of the material and which may be defined by a front and back cover area with a spine area therebetween.

It is further advantageous for the front cover of a binder to be customized with a document title indicative of the entity to which the binder belongs. While binders are often manufactured with a design or picture on the cover, the user may quickly tire of the design. However, since the user is incapable of changing the design or picture the user is forced to purchase another binder. Moreover, it becomes costly for the manufacturer to continue to produce binders with various designs or pictures, especially when such pictures include famous people, music bands, or themes. In addition, businesses desiring to customize binders for seminars or employees would further desire to have an inexpensive way of customizing the binders without having the costs associated with special ordering binders with personalized designs.

In an attempt to solve this problem and allow customization of binders by the purchasers, some binders may include a transparent overlay, typically formed of clear plastic. The overlay is normally sized equal or nearly equal to the size of the cover. The overlay is fused along its longitudinal edges and along the bottom edge forming a pocket in which a sheet of paper may be inserted. The overlay is further typically fused along the demarcations between the spine and the front and back covers, thereby providing a thin pocket sized to receive a spine insert. As a consequence the front cover and spine, and often times even the back cover are provided with pockets on their outer surfaces, which can receive an insert or printed sheet. However, the size and number of pockets tend to vary. For instance:

U.S. Pat. No. 5,876,143 to Ong discloses a pocket binder with separate cover and spine pockets permitting the user to custom insert a title sheet and a spine, but does not include a back pocket. The Ong patent also includes an embodiment showing two pockets on the front cover permitting a title sheet and optional panel information, which the owner may want to insert. In U.S. Pat. No. 5,720,564 to Winzen a binder is described as having a label holder or pocket that covers the spine and a portion of the front and back cover, but does not wrap around the entire cover. It is furthermore sized to receive a standard 8½″ by 11″ sheet of paper.

Thus the owner may create insert sheets using conventional home and office printers. However, difficulties arising from these pockets are that they either do not encompass the entire length of the cover (including front, back and spine) or since they are fused along the demarcations (between the spine and the front and back cover), they provide separate pockets for each the front, back and spine. Moreover, the pockets covering the front and/or back cover are oftentimes larger then standard sheets of paper, and the pockets covering the spine are so narrow that strips must be sized and cut from the original design, which the insertion of the strips is difficult. In most instances the spine insert must use a heavy card stock so the insertion is easier and the insert is less likely to tear.

While these types of pockets are suitable for their purposes it is further desired to create and print inserts that have a single design wrapping around the entire cover or a portion of the cover greater then one side. Utilizing programs that permit one to print banners, the user is able to print a design or title longer than a standard sheet of paper. The paper is then positioned end-to-end to form a continuous design, commonly known in the industry as “cross-over designs.” However, because the pockets are separately formed to the front, back and spine, the binders and pockets discussed above would require the user to cut or fold the design. Another difficultly, as mentioned above, is the size of the pockets. Since the front and back cover have widths larger than a standard 8½″ by 11″ size of paper, the front or back insert would not encompass the entire pocket, or if the pocket were sized only to receive the standard size paper, the insert would not cover the entire front or back portion. Furthermore, none of the other standard sized paper 17″ by 11″; 14″ by 8½″; or 5½″ by 8½″ will properly fit into these pockets.

As a consequence a need exists to provide a method, and article for providing a binder with a single pocket covering the entire length of the front, back and spine portions, permitting a user to create and insert a design that may be greater than any one portion. In addition, as further discussed in the detailed description, it would be further preferably for the user to be capable of printing the design from any standard office or home printer using standard size paper, such as 8½″ by 11″, to print multiple inserts. The multiple inserts when printed and properly tiled create a single continuous design that may be inserted into the single pocket creating an unbroken design disposed about the entire cover or any portion thereof. The small business, home office, and student will now have a professional look that will look dignified with outstanding presentations which resemble a printed full outside cover that would be otherwise cost prohibited.

### SUMMARY OF THE INVENTION

In accordance with the present invention a method for creating a single continuous and unbroken design tiled from multiple images individually printed and disposed about an article for viewing the design is described and illustrated. The preferred method includes the steps of receiving a design, resizing the design to a predetermined size, separating the images into multiple images, which when properly tiled form the design, and printing the design on multiple sheets of paper. The article is preferably a binder having a pocket disposed about the binder's cover. The pocket has an interior length substantially equal to the predetermined size, which when the properly tiled sheets are inserted in the pocket the sheets form a single, continuous, unbroken design which is viewed through the pocket. The pocket is preferably a clear overlay but may include in various embodiments lenticular lenses, which provide the ability to insert a combined flip design, such that when viewed through the lenticular lenses at various angles results in the separate visualization of the two designs or three dimensional designs. In addition the lenticular overlay may further be used to view three-dimensional designs that the method would permit the user to create and print.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is a perspective view of a binder in accordance with the prior art having pockets formed in the front, back and spine portions;

FIG. 2a illustrates three inserts which are specially sized to fit within the pockets formed in FIG. 1;

FIG. 2b is a perspective view of the binder from FIG. 1 with the inserts illustrated in FIG. 2a, showing a broken non-continuous design;

FIG. 3 is a perspective view of a binder in accordance with the present invention that includes a single pocket formed about the entire cover or at least formed about more than one portion, of the front, back and spine portions;

FIG. 4 is a block diagram illustrating the preferred method of the present invention;

FIG. 5a is a front view of a computer monitor illustrating the complete design;

FIG. 5b is an illustration of the design separated into multiple images;

FIG. 6 is a perspective view of a printer illustrating the steps of printing the multiple images, each having a portion of the overall design, which are inserted and overlapped in the binder from FIG. 3;

FIG. 7 is a perspective view of the binder with the multiple sheets tiled and inserted into the binder forming a single, continuous, unbroken design covering the entire or overall length of the pocket;

FIG. 8 is a perspective view of a binder having a lenticular lens flexible sheet overlay pocket which may receive a combined A+B flip image created in another embodiment of the preferred method; and

FIG. 9 is a perspective view of the binder from FIG. 8 rotated in two separate views showing the A+B flip image as it may be visualized through the lenticular lenses at specific angles.

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

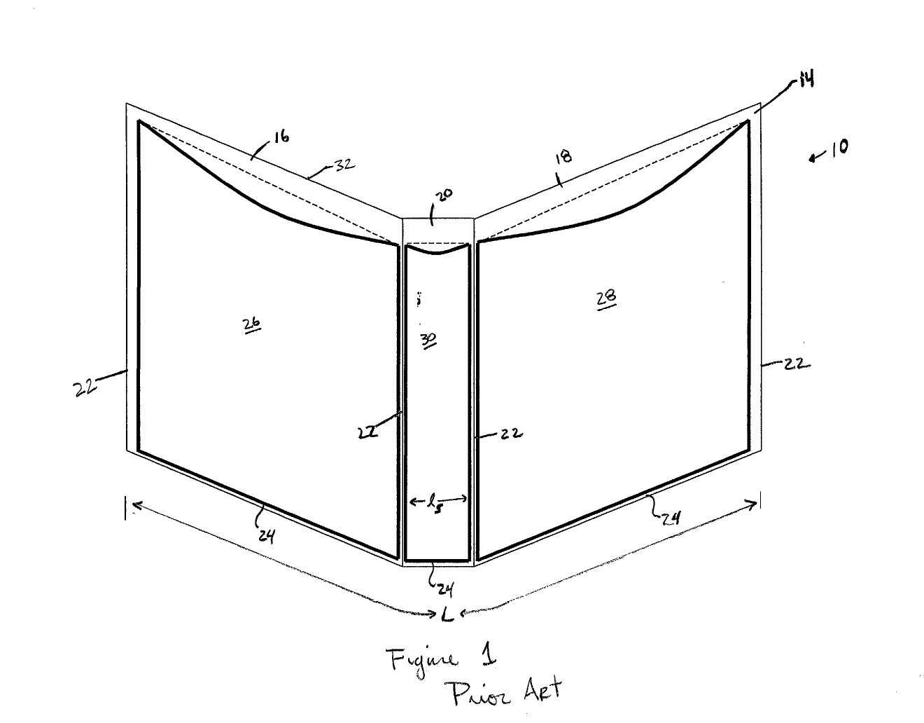

Referring now to FIG. 1, a binder in accordance with the prior art is illustrated and generally referenced to as 10. The binder 10 has a ring mechanism (not shown) which is of a predetermined ring capacity, such as ½″, ¾″, 1″, 1½″, 2″, ect. Typically, the cover 14 consists of three independent boards secured by well-known means forming three portions: a back 16, front 18 and spine 20. Some of these binders 10 also include multiple plastic sheets attached proximately to the side edges 22 and bottom edge 24 of each portion, thereby creating three independent pockets: a back pocket 26 covering the back portion 16, a front pocket 28 covering the front portion 18 and a spine pocket 30 for covering the spine portion 20. It is also well known that the total or overall length L of the back portion 16, front portion 18 and spine portion 20 changes for different ring capacity and different binder shapes, rendering a large inventory of differently shaped and sized binders. Moreover, since each binder has different sizes, the inserts for each would change or be differently sized to accommodate the overall length. It is also important to note that in some instances the plastic sheet is attached along the top edge 32. This is typically done if the cover includes artwork that the manufacturer wants permanently secured to the cover.

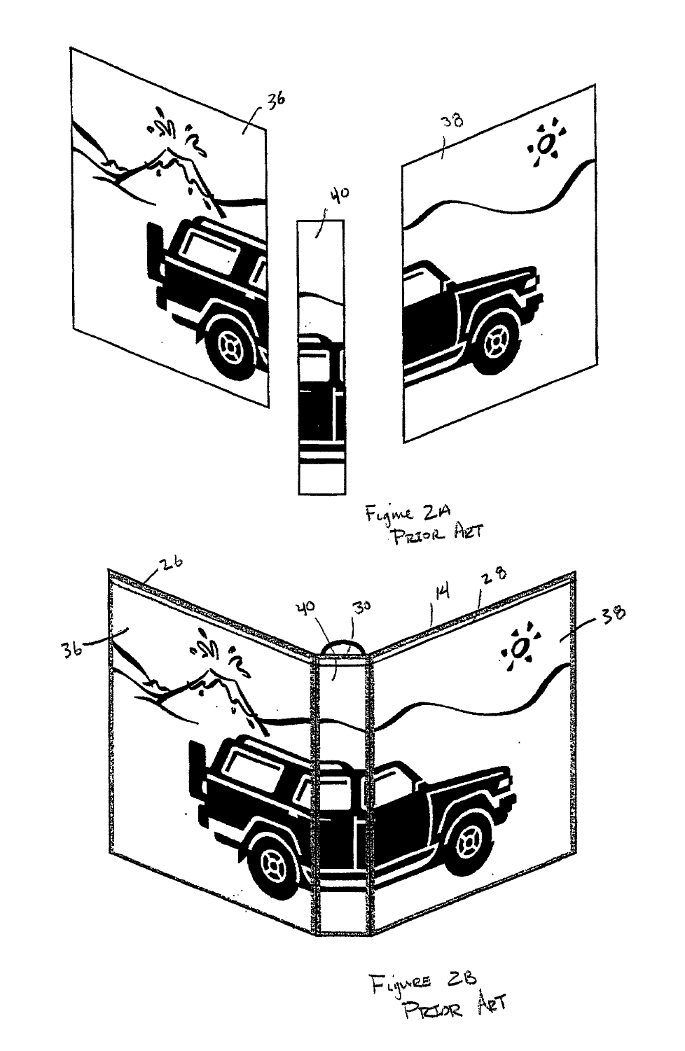

If the user desires to create artwork, images, pictures, etc. for the cover to personalize and customize the binder 10, the user must measure and cut three inserts. Referring now to FIGS. 2a and 2b, three inserts are shown: a back insert 36 for the back pocket 26, a front insert 38 for the front pocket 28, and a spine insert 40 for the spine pocket 30. While the images on the inserts may include any type of graphics, designs, pictures or words, it is oftentimes desired to have a single design for the entire cover 14, but because the pockets 26, 28 and 30 are separated the single design must be cut or divided into pieces or separate images. As illustrated in FIG. 2b the design positioned on the cover has blank spaces at the demarcations, leaving the design broken into separate images that may not even provide a viewer with the ability to determine what the design is, otherwise known in the art as a “cross over”. Furthermore, since the spine pocket is significantly narrower than the other pockets, it is difficult to place the spine insert 40 into its pocket, or if the user switches to a larger or smaller binder the width of the spine pocket will change rendering the inserts useless in any other sized binder. In addition, since the inserts are various sizes it becomes extremely difficult for the owner to create their own images or inserts from conventional home and office printers because the paper utilized by the printers may not correctly insert into the pockets without cutting or forming the paper.

A need therefore exists to provide a binder with a single pocket substantially formed to the entire length of the binder or a section of the binder greater than any one portion. The pocket would be capable of receiving multiple sheets of standard sized paper, permitting the user to create their own design and print the same from any standard home or office printer. However, as discussed previously, conventional banner programs will print designs that are larger than a single sheet of paper, but the programs often times center the images between the multiple pages and require the pages to be aligned as a cross-over design. If the pocket is smaller or greater than the total length of the end-to-end pages, the user must still cut or fold back the excess paper or have a portion of the cover remain blank. As such, a need also exists to provide a program that permits the user to print a design that covers the entire pocket or cover without requiring additional cutting by the user. This also permits the user to change the design without having to purchase a new binder or having to re-cut or form a new design every time.

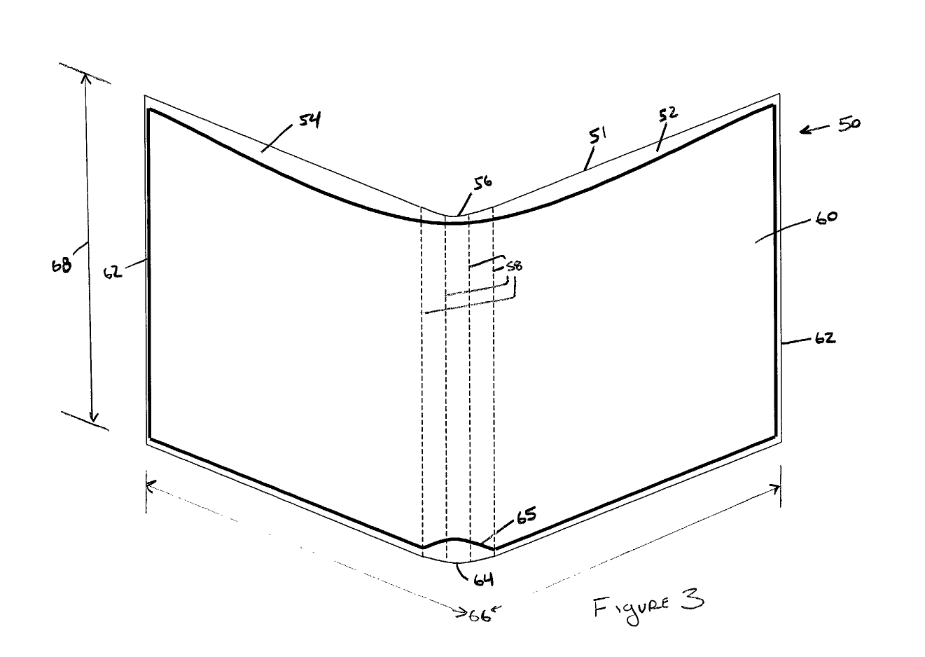

Referring now to FIG. 3, a binder 50 is illustrated as having a cover 51 with a front 52, back 54 and spine 56 area. Preferably the binder 50 is manufactured from a single uncompromised board with hinges 58 or knuckles longitudinally formed in the spine area 56. However, it is important to note that the binder may be manufactured conventionally and have three separate boards secured together by the plastic fused along the edges and demarcations, as discussed above or formed and hinged from a single plastic board. In either manner, in accordance therewith, the binder 50 includes at least one clear pocket 60 or a clear overlay plastic. The pocket 60 is secured or fused proximate to or along the outer edges 62 of the front area 52 and back area 54 and fused proximate to the bottom edge 64. It is further preferred to provide a binder 50 that has a predetermined standard overall length 66 that is equal to another binder similarly configured, even when the capacity of the ring mechanism (not shown) changes. This would provide a standard size pocket 60 such that the user may create and print a design or image to be inserted in any binder similarly configured, discussed in greater detail below. In addition the standard size pocket 60 would also preferably have a standard height or depth 68. The pocket 60 may also include a relief cut-out 65 on the bottom edge 64 proximate the spine area 56, in order to allow the overlay to lay flat without strain or wrinkles. It is important to note that the clear overlay plastic may also be fused at the edges of the binder, making the pocket substantially the same size as the binder itself.

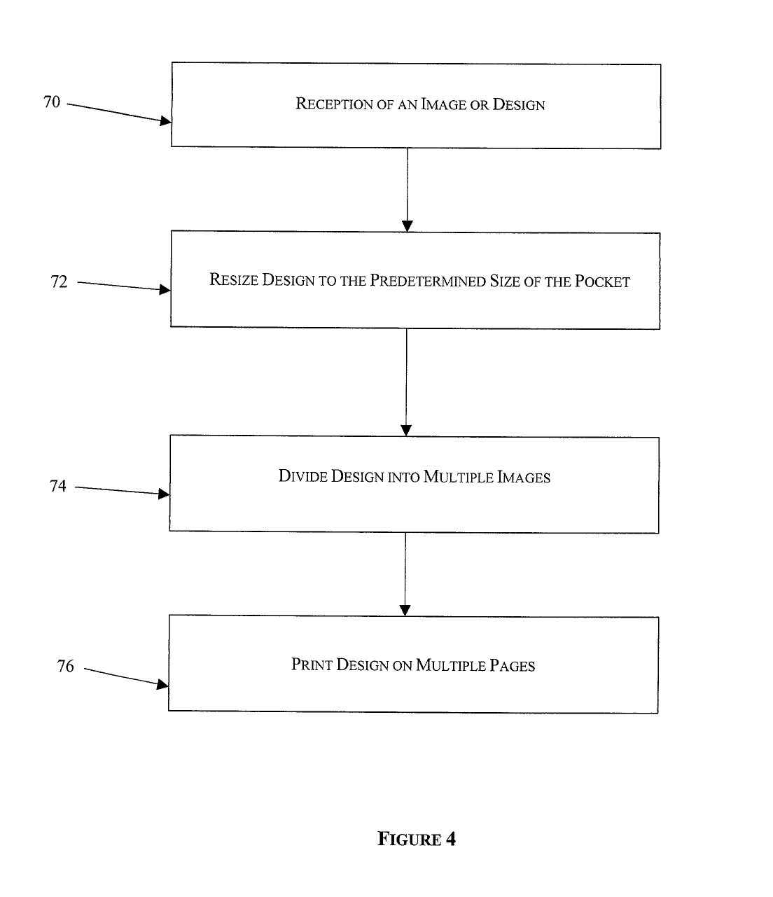

Referring now to FIG. 4, a flow diagram illustrates the preferred method for creating a single continuous design tiled from multiple images, which may be disposed about the cover 51 for the aforementioned binder 50. The method begins by receiving a design, step 70. Also, the user may create or retrieve the design in any well-known graphic program, such as clip art, stock photo, font bank, etc. Alternatively, the design may be scanned from a photograph, or imported or downloaded from any graphic program, or may be designed in a word processing program and consist entirely of words, symbols, characters, or numbers. Following step 70, the method will then resize the design to the predetermined size of the pocket 60, step 72. After the design is resized, the method divides or separates the design into multiple images, step 74, which when properly aligned and tiled, form the design. The method then prints the multiple images on corresponding pages, step 76.

These steps may further contain additional elements that would facilitate the same. In step 72, preferably the size of the pocket 60 is the same for every binder 100 and is not dependent upon the capacity of the ring mechanism. If such instances, the overall binder may be approximately 22½″ in overall length and 11½″ in depth, and as such the method would automatically resize the design to fit inside a pocket matching these parameters. However, it is also conceivable to include an additional step that requests the user to input the size of the pocket or overall size of the binder. For instance, if the pocket were only 14″ in overall length, covering the front area and the spine area then the method would resize the image or design in accordance with this predetermined overall length.

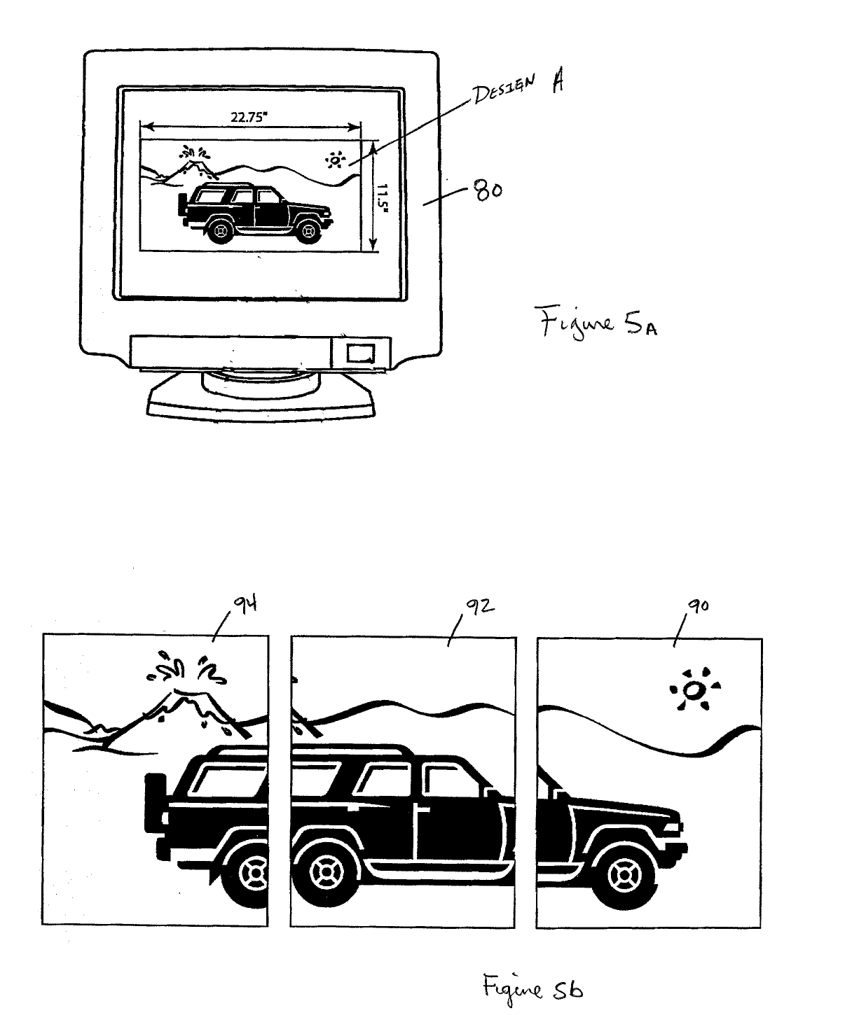

In accordance with one exemplary embodiment, the overall binder is 22½″ in overall length and 11½″ in depth, having a pocket 60 sized to receive an insert with a total length of 22¼″ by 11¼″. Illustrated in FIG. 5a, a conventional computer monitor 80 is shown with a design A. The design A is resized to the predetermined dimensions of 22¼″ by 11¼″. The design A is also unbroken and is shown in its completed fashion.

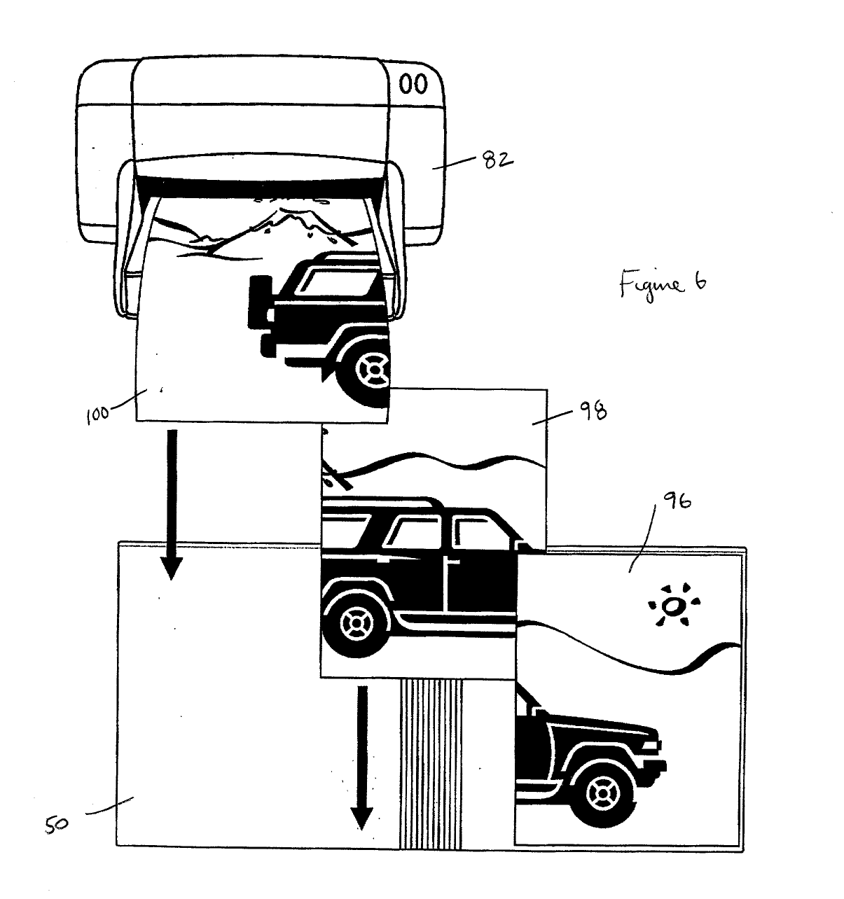

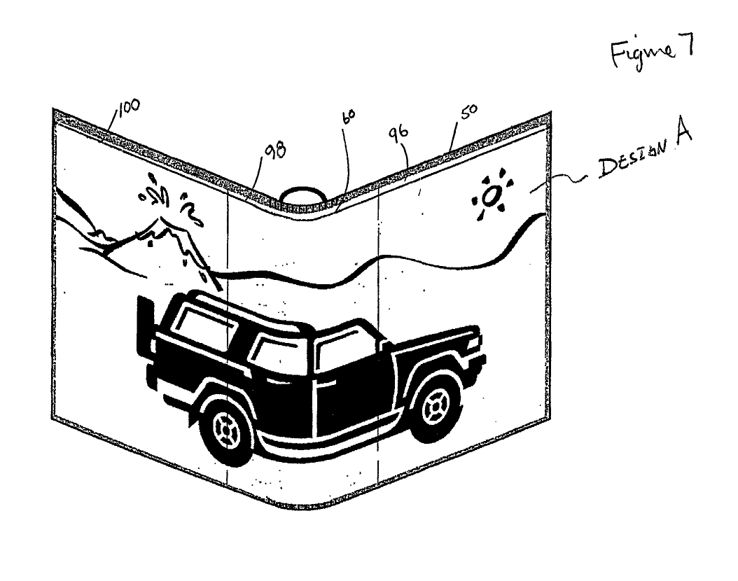

Once the image is resized and the user wants to print the design, the method, divides or separates it into multiple images, illustrated in FIG. 5b. While typically not shown to the user, FIG. 5b illustrates the divided images. Since standard paper in the United States is 17″, 14″, 8½″, or 5½″ in length, the image must be divided on at least two sheets. However, the multiple sheets would have a total end-to-end length greater than the 22¼″ pocket 60 for the 22½″ binder 50, for example, three sheets of 8½″ by 11″ paper has an end-to-end total length of 25½″. In order to provide the images on multiple sheets without having the user cut or reshape the pages, the method will overlap the images, illustrated in FIGS. 6 and 7. It is also important to note that while the preferred embodiment utilizes 8½″ wide paper the size of the paper may be selected or changed by the user, such as using A4 sized paper, commonly used in Europe. The method would then divide the design properly into the least images needed to complete the design. For example, with a predetermined size of 22¼″×11″, the method would divide and print the design onto 3—8½″×11″ sheets of paper, or 2—14″×11″ sheets. Moreover, it is further conceivable to use additional sheets or mix the size of the sheets as so desired, for instance, the aforementioned predetermined size may be divided and printed on 1—14″×11″ sheet and one 8½″×11″ sheet; or 4 sheets of 8½″×11″ paper.

Still referring now to FIG. 5b, the image A is divided into the three images 90, 92 and 94 sequentially, which may be printed onto standard sheets of paper using any conventional home or office printer 82, FIG. 6. The method then prints the multiple images on the standard sheets of paper, which for example purposes only is shown as three 8½″ by 11″ pages, 96, 98 and 100. The three sheets 96, 98 and 100 may be inserted into the pocket 60 of the binder 50, such that when the sheets are properly aligned and overlapped or tiled the images on the sheets form a single, continuous, unbroken design A, shown in FIG. 7, rather than the broken design shown in FIG. 3.

In addition it has been further determined, that by using a clear vinyl overlay, as the pocket, and an opaque vinyl cover, covering the binder, the inserts will be held in place by statically charged particles between the two vinyl sheets. As such, the inserts or sheets of paper will therefore be held in place, keeping the single tiled design continuous.

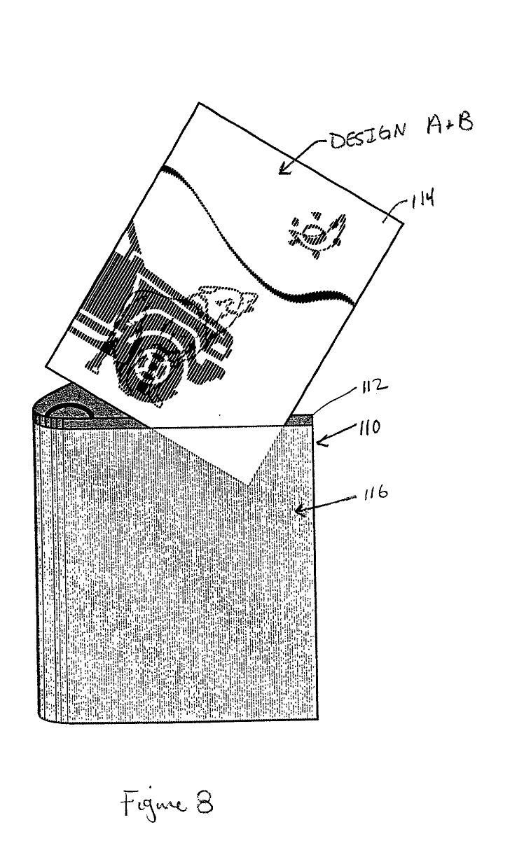

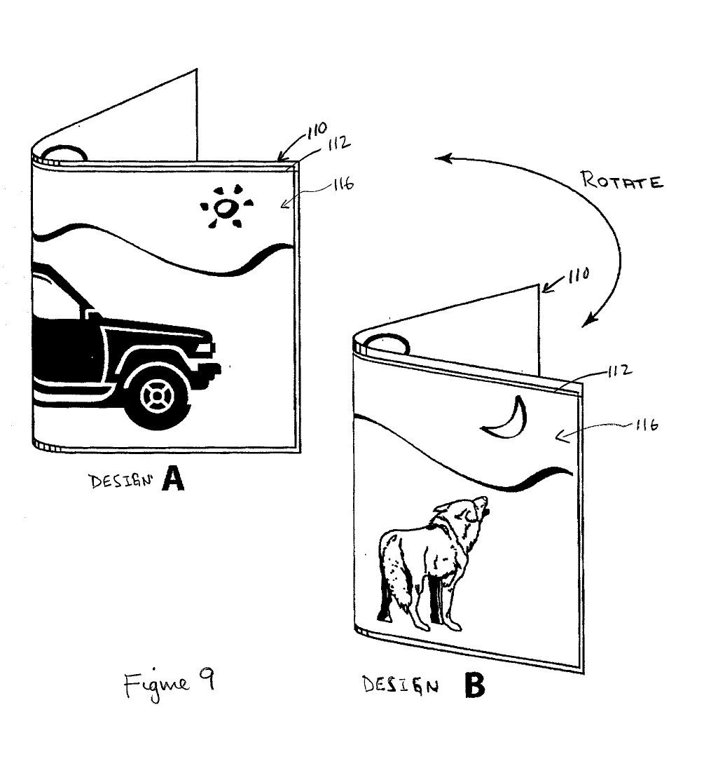

Referring now to FIG. 8, in another embodiment the method may also include special effects that enhance the users value and further differentiates the present invention from others available. One such method would include the necessary steps to receive more than one design, for example, two designs A and B. The method would then strip the two designs and alternately interlace or splice the strips to form a combined A+B flip design. The method would have also removed portions of the designs such that the combined A+B flip design would not have an overall length greater than the predetermined length. The combined design may then be resized and printed on multiple sheets as previously discussed (only the first sheet 114 is shown) and be inserted into a binder 110 with a overlay pocket 112 that includes lenticular lenses 116. The combined A+B design, when properly aligned in the lenticular overlay pocket 112, will visually re-create the two designs A and B when the binder is rotated and viewed through a proper angle, shown in FIG. 9. While FIGS. 8 and 9, only show a single sheet, when completed the binder 110 would include multiple sheets of inserts with images printed thereon, such that the entire combined A+B flip design would be viewable about the cover of the binder 110.

In addition thereto, the combined A+B flip design can contribute various special effects to the viewer. For instance the flip design can be arranged such that the pictures morph, zoom, or visually shows motion. Alternatively, multiple designs can be combined to provide a three-dimensional design. In these various embodiments the clear overlay or pocket may be high dome embossing with a wide angle of view, clear for the A+B flip or low dome embossing with narrow angle of view, clear for three-dimensional designs. As known in the art when the lenticular overlay is designed for an A+B flip image the lenticular lenses have a high profile such that the image shifts as the binder rotates approximately every 47°, and when designed for three-dimensional images the lenticular lenses have a low profile such that the image shifts as the binder rotates approximately every 23°.

The methodology of the invention, as discussed above may be programmed and stored, in a processor with its associated memory and other equivalent components, as a set of program instructions for subsequent execution when the processor is operative. In addition, the program instructions may further prescribe a graphic user interface for the user to adequately accomplish the above. In yet further embodiments, the program may be stored and accessed at a website on the Internet. From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

1. A computer implemented method for creating a single continuous design tiled from at least two inserts used in combination with a binder at least having a cover with a clear pocket disposed about said cover and wherein the pocket has a predetermined length, the method comprising:
receiving at least one design;
resizing the design to said predetermined length of said pocket;
separating the design into at least two images, said images when properly aligned and overlapped form said design;
separately printing the images on corresponding inserts to be placed in said clear pocket of said binder,
whereby when placing properly aligned and overlapped inserts in said pocket, the images on said corresponding inserts form a single continuous design substantially the same as said design.

2. The method of claim 1 further comprising the step of inputting the predetermined length.

3. The method of claim 1, wherein the predetermined length is approximately 22¼ inches.

4. The method of claim 3, wherein the step of separating the design into at least two images includes separating the design into three images.

5. The method of claim 4, wherein the inserts are three standard sheets of paper, each having a width of about 8½ inches.

6. The method of claim 1, wherein the step of receiving at least one design includes receiving at least two designs.

7. The method of claim 6 further comprising the step of:
striping, removing portions thereof and splicing the at least two designs to form a single combined design comprised of the at least two striped and spliced designs, the combined design having a length substantially equal to the predetermined length, and
wherein said clear pocket includes lenticular lenses so that when the inserts are properly aligned and overlapped and placed in said clear pocket, only one design of said two designs can be viewed from a first angle and a different design of said two designs can be viewed from a second angle.

8. The method of claim 7, wherein the at least two designs consists of at least three designs such that when combined and inserted into the clear pocket with lenticular lenses the combined design visually forms a three-dimensional design.

9. A computer implemented method for creating a single continuous design tiled from multiple images comprising:
receiving a design;
resizing the design to a predetermined length;
separating the design into at least two images, said images when properly tiled form said design; and
printing each images on a corresponding standard sheet of paper.

10. The method of claim 9, wherein the sheets of paper may be inserted into a clear overlay pocket formed on a cover of a binder, wherein the pocket has an internal length equal to the predetermined length,
whereby when the sheets of paper are properly tiled in the pocket, the sheets of paper form the single unbroken continuous design substantially similar to said design.

11. The method of claim 10, wherein:
the predetermined length is approximately 22¼ inches,
the step of separating the design into at least two images includes separating the design into three images, and
the step of printing each image on a corresponding standard sheet of paper includes printing each image on an 8½ inch by 11 inch sheet of paper.

12. The method of claim 8 further comprising the steps of:
receiving at least a second design;
stripping each design by substantially removing and deleting portions of each design and alternately splicing the strips of each design to form a combined design made up of the alternately spaced strips of the two designs, wherein the combined design has a length substantially equal to said predetermined length.

13. The method of claim 12, wherein the sheets of paper may be inserted into a clear overlay pocket having a plurality of lenticular lenses thereon, the overlay pocket being formed on a cover of a binder, wherein the pocket has an internal length equal to the predetermined length, wherein when the sheets of paper are properly tiled in the pocket, the sheets of paper form a single unbroken continuous design substantially similar to said combined design and when said combined design is viewed from one angle, the lenticular lenses opaque all but one of the designs in said combined design and when viewed at another angle, the lenticular lenses opaque all but one other design in said combined design.

14. The method of claim 8, wherein the design is a three-dimensional design which may be inserted into a clear overlay pocket having a plurality of low dome embossing lenticular lenses providing a narrow angle of view, such that when the sheets of paper are properly tiled in the pocket, the sheets of paper form a single unbroken continuous design substantially similar to said three-dimensional design and when viewed through said pocket visually creates the three-dimensional design.

15. A binder having a cover with a bottom edge, top edge and two opposed side edges defining at least a front, back and spine area, further comprising:
a clear overlay material having a top, bottom and two opposed sides, the bottom side of said clear overlay material being attached proximate to the bottom edge of the cover, and the two opposed sides of said clear overlay material being separately attached proximate to the two opposed side edges forming a pocket, the pocket having a predetermined length defined as the interior length of the pocket extending from the two opposed sides of said clear overlay material.

16. The binder of claim 15, wherein the pocket has a cut-out along the bottom edge of the cover about the spine area.

17. The binder of claim 15 or 16, further including:
at least two inserts each having an image, which when the inserts are properly aligned and overlapped, the images form a single continuous unbroken design, and the at least two inserts when properly aligned, have a length substantially equal to the predetermined length of said pocket, whereby when properly aligned and inserted into the pocket, the at least two separate inserts form said single continuous unbroken design wrapping about the cover of the binder.

18. The binder of claim 17, wherein the inserts are three 8½ inch by 11 inch sheets of paper, which when properly aligned and overlap form a substantially single continuous unbroken design with a predetermined length of approximately 22¼ inches.

19. The binder of claim 17, wherein the clear overlay material includes lenticular lenses such that when the inserts are properly aligned and overlapped, the images form a combined design made from splicing at least two designs together, and when the inserts are placed in the pocket and when said combined design is viewed from one angle the lenticular lenses opaque all but one of the designs in said combined design and when viewed at another angle the lenticular lenses opaque all but one other design in said combined design.

20. The method of claim 17, wherein the clear overlay material includes low dome embossing lenticular lenses providing a narrow angle of view, and wherein when the inserts having three-dimensional images printed thereon are properly tiled in the pocket visually forms a single unbroken continuous three-dimensional design.

21. A binder having a cover with a bottom edge, top edge and two opposed side edges defining at least a front, back and spine area, further comprising:
a clear overlay material having a top, bottom and two opposed sides, the bottom side of said clear overlay material being attached proximate to the bottom edge of the cover, and the two opposed sides of said clear overlay material being separately attached proximate to the two opposed side edges forming a pocket, the pocket having a predetermined length defined as the interior length of the pocket extending from the two opposed sides of said clear overlay material; and
at least two inserts each having an image, which when the inserts are properly aligned and overlapped, the images form a single continuous unbroken design, and the at least two inserts when properly aligned, have a length substantially equal to the predetermined length of said pocket, whereby when properly aligned and inserted into the pocket, the at least two separate inserts form said single continuous unbroken design wrapping about the cover of the binder.
